(19) United States
(12) Patent Application Publication
(10) Pub. No.: US 2009/0148674 A1
(43) Pub. Date: Jun. 11, 2009

(54) IN MOLD FILM WITH A 2D/3D PATTERN

(75) Inventor: Victor Shi-Yueh Sheu, San-Chung City (TW)

Correspondence Address: PAI PATENT & TRADEMARK LAW FIRM, 1001 FOURTH AVENUE, SUITE 3200, SEATTLE, WA, 98154, US

(73) Assignee: ULT TECHNOLOGY CO., LTD., San-Chung City (TW)

(21) Appl. No.: 11/953,064

(22) Filed: Dec. 9, 2007

(51) Int. Cl. B32B 3/00

(52) U.S. Cl. 428/201

(57) ABSTRACT

Both in mold film and in mold label with a 2D or 3D pattern include a base layer, which has a flat inner surface and an outer surface that can be a 2D visual surface or 3D grating surface, a pattern layer printed on the inner surface of the base layer to show a 2D or 3D pattern, a protective layer prepared from a polymer material having high temperature resistance, acid resistance and alkali resistance characteristics and printed on the pattern layer, and an adhesion layer covered on the protective layer. In an alternate form, an anti-EMI layer is sandwiched between the protective layer and the adhesion layer for electromagnetic interference protection.

### BACKGROUND OF THE INVENTION

(a) Field of the Invention

The present invention relates to in mold films and in mold labels, and more particularly to both the in mold film and in mold label with a 2D or 3D pattern, which has a 2D or 3D pattern layer and a protective layer printed on the 2D or 3D pattern layer for adhesion to a molding product during injection or pressure casting molding of the product.

(b) Description of the Prior Art

In mold film (IMF) and in mold labeling (IML) techniques have been intensively used in the fabrication of shells for notebook computers, palm-top computers, wireless communication products, consumer electronic products, telecommunication systems, vehicle parts, electric home appliances, etc. In mold film and labeling techniques have also been intensively used in the fabrication of cell phones, keyboards, and food containers to provide a fine shape and colorful design for generating a unique sense of beauty. In mold film and labeling techniques enable the outer or external part of the product to have an integrated 2D or 3D pattern attractive to consumers.

Further, the material of a grating plate itself or the ink to be used for printing a pattern on a grating plate will be deformed when heated to a certain temperature level. Therefore, a printed grating plate cannot stand the high temperature environment during an in mold film or in mold labeling process. Therefore, decorating a product shell with a 2D or 3D pattern is generally achieved by printing a grating plate with 2D or 3D pattern and then adhering the pattern-printed grating plate to the surface of the product shell or inserting the pattern-printed grating plate into the inside of the product shell. By this method high quantity products cannot be obtained because the grating plate is not integrally formed with the product shell.

### SUMMARY OF THE INVENTION

The present invention has been accomplished under the circumstances in view. According to one aspect of the present invention, both the in mold film and in mold label comprise a base layer, an adhesion layer, a pattern layer disposed between the base layer and the adhesion layer, and a protective layer disposed between the pattern layer and the adhesion layer. The base layer is prepared from a polymer material, having an inner surface, and a 2D visual surface or a 3D grating surface opposite to said inner surface. The pattern layer is prepared from a polymer material and printed on the inner surface of the base layer to show a 2D or 3D pattern. The protective layer is prepared from a polymer material having high temperature resistance, acid resistance and alkali resistance characteristics, and printed on one side of the pattern layer opposite to the base layer. The adhesion layer is covered on one side of the protective layer opposite to the pattern layer. The in mold film and in mold label with a 2D or 3D pattern thus obtained can be directly molded on one product member during injection molding or pressure-casting molding of the product member so that the product member has an integrated 2D or 3D pattern.

According to another aspect of the present invention, the protective layer is prepared from polyethylene terephthalate (PET), polyimide (PI), polypropylene (PP), polyurethane (PU), polymethylmethacrylate (PMMA), polycarbonate (PC), polybutylene terephthalate (PBT), nylon, silicone, or a mixture thereof, which has high temperature resistance acid resistance, and alkali resistance characteristics. The protective layer enhances the mechanical properties and physical strength of the material, and provides excellent adhesion. The protective layer also enhances the photo effects of the 2D or 3D pattern layer.

According to still another aspect of the present invention, the in mold film and in mold label further comprise an anti-EMI layer prepared from an electromagnetic interference (EMI) protective material and sandwiched between the protective layer and the adhesion layer for protection against electromagnetic interference.

### BRIEF DESCRIPTION OF THE DRAWINGS

FIG. 1 is a schematic drawing showing both the in mold film and in mold label with a 2D pattern according to the present invention.

FIG. 2 is a schematic drawing showing both the in mold film and in mold label with a 3D pattern according to the present invention.

FIG. 3 is a schematic drawing of the present invention showing both the in mold film and in mold label molded to an injection molding or pressure casting molding product.

FIG. 4 is a schematic drawing of an alternate form of the in mold film and in mold label according to the present invention, including an anti-EMI layer sandwiched between the protective layer and the adhesion layer.

### DETAILED DESCRIPTION OF THE PREFERRED EMBODIMENTS

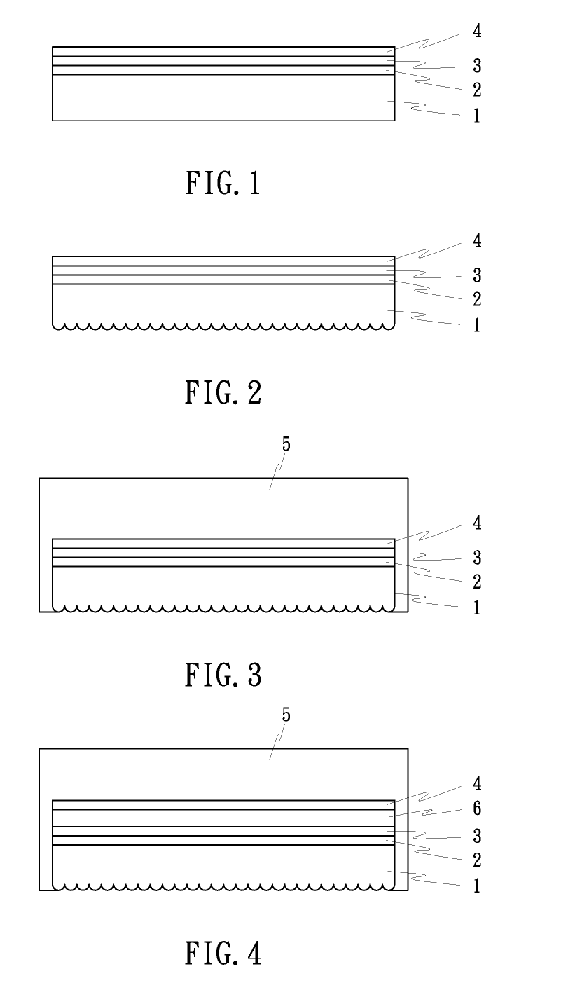

Referring to FIGS. 1 and 2, both the in mold film and in mold label with a 2D/3D pattern in accordance with the present invention comprises a base layer 1, a pattern layer 2, a protective layer 3, and an adhesion layer 4.

The base layer 1 is prepared from a polymer compound material such as polyethylene terephthalate (PET), polyimide (PI), polypropylene (PP), polystyrene (PS), polyurethane (PU), polymethylmethacrylate (PMMA), polycarbonate (PC), polybutylene terephthalate (PBT), acrylonitrile butadiene styrene (ABS), nylon, or a mixture thereof. The base layer 1 can be made to have a visual surface (see FIG. 1) suitable for the printing of a 2D mirror image pattern, or a grating surface (see FIG. 2) suitable for the printing of a 3D mirror image pattern. In the following embodiments, the base layer 1 has a grating surface, and is suitable for the printing of a 3D mirror image pattern.

The pattern layer 2 is prepared from a polymer material such as PET, PI, PP, PU, PMMA, PC, PBT, nylon, silicone, or a mixture thereof. The pattern layer 2 can be a 2D or 3D pattern printed on the inner surface of the base layer 1 by means of any of a variety of printing techniques, such as gravure printing, flexographic printing, lithographic printing, screen printing, or transfer printing. The printing is a mirror image printing. Therefore, the positive image is seen from the outer side of the base layer 1.

The protective layer 3 is prepared from a polymer material such as PET, PI, PP, PU, PMMA, PC, PBT, nylon, silicone, or a mixture thereof, and is directly printed on one side of the pattern layer 2 opposite to the base layer 1. The protective layer 3 has high temperature resistance, acid resistance, and alkali resistance characteristics. It enhances the mechanical properties and physical strength of the material, and provides excellent adhesion. It also enhances the photo effects of the 2D or 3D pattern layer 2.

The adhesion layer 4 is prepared from a polymer compound material such as PET, PI, PP, PS, PU, PMMA, PC, PBT, ABS, or nylon, and is covered on the surface of the protective layer 3.

By means of in mold decoration technology, the in mold films and in mold labels thus obtained are directly adhesive to an injection-molding/pressure casting molding product 5 during injection (pressure casting) molding of the molding product 5 (see FIG. 3). Therefore, the molding product 5 has a 2D or 3D pattern layer 2 in it.

As stated above, the base layer 1 can be made to have a visual surface suitable for the printing of a 2D mirror image pattern, or a grating surface suitable for the printing of a 3D mirror image pattern. Direct printing of graphics on the grating surface will show a motion effect or other 3D motion picture effects.

The pattern layer 2 can be made by means of single-layer printing or multi-layer printing.

FIG. 4 shows an alternate form of the present invention. According to this embodiment, an anti-EMI layer 6 is sandwiched between the protective layer 3 and the adhesion layer 4. The anti-EMI layer 6 is prepared from Mg, Al, Cu, Ni, Cr, or an alloy thereof for electromagnetic interference (EMI) protection. When a molding product is molded with the in mold film and in mold label made according to this embodiment, the molding product provides an EMI protective function.

Further, the ratio of the base layer 1 both in mold film and in mold label are about 50%˜80%; the ratio of the pattern layer 2 both in mold film and in mold label are about 3%˜10%; the ratio of the protective layer 3 both in mold film and in mold label are about 5%˜10%; the ratio of the adhesion layer 4 both in mold film and in mold label are about 3%˜10%; the ratio of the anti-EMI layer 6 both in mold film and in mold label are about 9%˜20%.

Although a particular embodiment of the invention has been described in detail for purposes of illustration, various modifications and enhancements may be made without departing from the spirit and scope of the invention. Accordingly, the invention is not to be limited except as by the appended claims.

What is claimed is:

1. An in mold film comprising a base layer, an adhesion layer, a pattern layer disposed between said base layer and said adhesion layer, and a protective layer disposed between said pattern layer and said adhesion layer, wherein
said base layer is prepared from a polymer material and includes an inner surface, and a 2D visual surface or a 3D grating surface opposite to said inner surface;
said pattern layer is prepared from a polymer material and printed on the inner surface of said base layer to show a 2D or 3D pattern;
said protective layer is prepared from a polymer material having high temperature resistance, acid resistance and alkali resistance characteristics and printed on one side of said pattern layer opposite to said base layer; and
said adhesion layer is covered on one side of said protective layer opposite to said pattern layer.

2. An in mold film as claimed in claim 1, wherein said base layer is prepared from PET, PI, PP, PS, PU, PMMA, PC, PET, ABS, nylon, or a mixture thereof.

3. An in mold film as claimed in claim 1, wherein said pattern layer is prepared from PET, PI, PP, PU, PMMA, PC, PBT, nylon, silicone, or a mixture thereof.

4. The in mold film as claimed in claim 1, wherein said protective layer is prepared from PET, PI, PP, PU, PMMA, PC, PBT, nylon, silicone, or a mixture thereof.

5. The in mold film as claimed in claim 1, wherein said adhesion layer is prepared from PET, PI, PP, PS, PU, PMMA, PC, PBT, ABS, nylon, or a mixture thereof.

6. The in mold film as claimed in claim 1, wherein said pattern layer is formed of multiple layers by means of a multi-layer printing process.

7. The in mold film as claimed in claim 1, further comprising an anti-EMI layer prepared from an electromagnetic interference protective material and sandwiched between said protective layer and said adhesion layer.

8. The in mold film as claimed in claim 7, wherein said. electromagnetic interference protective material is a metal material selected from the group consisting of Mg, Al, Cu, Ni, Cr, and their alloys.

9. The in mold film as claimed in claim 1, wherein the ratio of said base layer in the in mold film is 50%˜80%; the ratio of said pattern layer in the in mold film is about 3%˜10%; the ratio of said protective layer in the in mold film is 5%˜10%;
the ratio of said adhesion layer in the in mold film is 3%˜10%.

10. The in mold film as claimed in claim 7, wherein the ratio of said anti-EMI layer in the in mold film is 9%˜20%.
